(19) United States
(12) Patent Application Publication
(10) Pub. No.: US 2015/0364745 A1
(43) Pub. Date: Dec. 17, 2015

(54) BATTERY PACK

(71) Applicant: SAMSUNG SDI CO., LTD., Yongin-si (KR)

(72) Inventors: Han-Jun Wang, Yongin-si (KR); Dae-Yon Moon, Yongin-si (KR)

(21) Appl. No.: 14/461,077

(22) Filed: Aug. 15, 2014

(30) Foreign Application Priority Data
Jun. 12, 2014 (KR) 10-2014-0071493

(51) Int. Cl. H01M 2/34

(52) U.S. Cl. CPC H01M 2/348; H01M 2200/10

(57) ABSTRACT

A battery pack is disclosed. In one aspect, the battery pack includes first and second battery units having a substantially prismatic shape and separated from each other, and a protective circuit module electrically connected to the first and second battery units. The battery pack also includes a case accommodating the first and second battery units, a rib formed between the first and second battery units, and a temperature sensor accommodated in a space defined by the rib. Lateral sides of the first and second battery units face each other.

### INCORPORATION BY REFERENCE TO ANY PRIORITY APPLICATIONS

This application claims the benefit of Korean Patent Application No. 10-2014-0071493, filed on Jun. 12, 2014, in the Korean Intellectual Property Office, the disclosure of which is incorporated herein in its entirety by reference.

### BACKGROUND

1. Field

The described technology generally relates to a battery pack.

2. Description of the Related Technology

With the advent of wireless Internet and communication technology, the use of portable computing devices such as tablets and laptop computers equipped with batteries has become ubiquitous.

These devices are small, easy to carry, and optimized for mobility, and thus, widely used for both business and personal purposes. Portable devices including internal or external battery packs can be used anywhere without being limited to places where power outlets are available. These battery packs typically include secondary batteries that are rechargeable.

### SUMMARY OF CERTAIN INVENTIVE ASPECTS

One inventive aspect is a battery pack.

Another aspect is a battery pack that includes: a plurality of battery units, each of the plurality of battery units including a can having an opening, an electrode assembly accommodated in the can and having a first electrode plate, a second electrode plate, and a separator disposed between the first and second electrode plates, a cap plate sealing the opening of the can, and an electrode tab disposed on the cap plate; a protective circuit module disposed adjacent to sides of the plurality of battery units and electrically connected to the plurality of battery units; a case accommodating the plurality of battery units; a temperature sensor; and a rib disposed between neighboring battery units of the plurality of battery units and forming an accommodation space for the temperature sensor.

The neighboring battery units of the plurality of battery units can be arranged side by side such that the cap plates of the neighboring battery units can be exposed in the same direction, and the protective circuit module can be disposed adjacent to the cap plates of the neighboring battery units.

Each of the plurality of battery units can have a prismatic shape, the neighboring battery units can be arranged in such a manner that lateral sides of the neighboring battery units can face each other, and the lateral sides of the neighboring battery units can be substantially perpendicular to the cap plates of the neighboring battery units.

The rib can include: a first part extending in one direction; and a second part substantially perpendicular to the first part.

The first part can extend in a length direction of the lateral sides of the neighboring battery units.

The second part can have substantially the same width as a width of a gap formed between the neighboring battery units.

The temperature sensor can include a thermistor.

The plurality of battery units can be connected in series, parallel, or series-parallel through a circuit pattern of the protective circuit module.

The temperature sensor can be disposed to be substantially parallel to a length direction of the neighboring battery units.

The battery pack can further include an adhesive insulation film disposed on the temperature sensor accommodated in the rib.

The can can be formed of a metallic material.

Another aspect is a battery pack that includes: first and second battery units having a prismatic shape and separate from each other, lateral sides of the first and second battery units facing each other; a protective circuit module electrically connected to the first and second battery units; a case accommodating the first and second battery units; a rib formed on the case at a position between the first and second battery units; and a temperature sensor disposed in an accommodation space defined by the rib.

The first battery unit can include an electrode tab formed on a front side of the first battery unit, and the front side of the first battery unit can be placed on a plane different from a plane on which the lateral side of the first battery unit is placed. The second battery unit can include an electrode tab formed on a front side of the second battery unit, and the front side of the second battery unit can be placed on a plane different from a plane on which the lateral side of the second battery unit is placed.

The first and second battery units can be arranged side by side such that the electrode tabs of the first and second battery units can be exposed in the same direction.

The protective circuit module can be disposed adjacent to the electrode tabs of the first and second battery units.

The temperature sensor can be disposed in a length direction of the lateral sides of the first and second battery units, and the protective circuit module can extend in a direction substantially perpendicular to the length direction in which the temperature sensor can be disposed.

The rib can include a fixing part making contact with the lateral sides of the first and second battery units for preventing wobbling of the first and second battery units.

The fixing part can have substantially the same width as a width of a gap formed between the first and second battery units.

The first and second battery units can be connected in series or parallel through the protective circuit module.

The battery pack can further include an adhesive member disposed on the temperature sensor accommodated in the rib.

Another aspect is a battery pack comprising a plurality of battery units. Each battery unit comprises a container, an electrode assembly accommodated in the container and including first and second electrode plates and a separator placed therebetween, a cap plate substantially sealing the electrode assembly in the container, and an electrode tab placed on the cap plate. The battery pack also comprises a protective circuit module placed adjacent to sides of the battery units and electrically connected to the battery units, a case accommodating the battery units, a temperature sensor, and a rib placed between neighboring battery units and accommodating the temperature sensor.

In the above battery pack, the neighboring battery units are arranged side by side such that the cap plates face substantially the same sides, of the battery units, wherein the protective circuit module is placed adjacent to the cap plates. In the above battery pack, each battery unit has a substantially prismatic shape, wherein lateral sides of the neighboring battery units are arranged to face each other, and wherein the lateral sides are substantially perpendicular to the cap plates of the neighboring battery units.

In the above battery pack, the rib comprises a first portion extending in a first direction and a second portion extending in a second direction crossing the first direction. In the above battery pack, the first direction extends substantially parallel to the lateral sides. In the above battery pack, the second portion has substantially the same width as the width of a gap formed between the neighboring battery units.

In the above battery pack, the temperature sensor comprises a thermistor. In the above battery pack, the battery units are electrically connected in series, parallel, or a combination thereof via a circuit pattern of the protective circuit module. In the above battery pack, the temperature sensor is substantially parallel to a length direction of the neighboring battery units. The above battery pack further comprises an adhesive insulation film placed on the temperature sensor. In the above battery pack, the container is formed of a metal.

Another aspect is a battery pack comprising first and second battery units having a substantially prismatic shape and separated from each other, wherein lateral sides of the first and second battery units face each other. The battery pack also comprises a protective circuit module electrically connected to the first and second battery units, a case accommodating the first and second battery units, a rib formed between the first and second battery units, and a temperature sensor accommodated in the rib.

In the above battery pack, the first and second battery units each comprises an electrode tab placed on a front side of the respective battery unit, wherein the front side and the lateral side are placed on different planes. In the above battery pack, the first and second battery units are arranged side by side such that the electrode tabs face the same sides of the first and second battery units.

In the above battery pack, the protective circuit module is placed adjacent to the electrode tabs. In the above battery pack, the temperature sensor extends in a length direction of the lateral sides, wherein the protective circuit module extends in a direction crossing the length direction.

In the above battery pack, the rib comprises a fixing portion contacting the lateral sides so as to prevent wobbling of the first and second battery units. In the above battery pack, the fixing portion has substantially the same width as a width of a gap formed between the first and second battery units. In the above battery pack, the first and second battery units are electrically connected in series or parallel via the protective circuit module. The above battery pack further comprises an adhesive member placed on the temperature sensor.

### BRIEF DESCRIPTION OF THE DRAWINGS

FIG. 1 is a perspective view illustrating a battery pack according to an embodiment.

FIG. 2 is an exploded perspective view illustrating the battery pack illustrated in FIG. 1.

FIG. 3 is a plan view illustrating an upper side of the battery pack illustrated in FIG. 1.

FIG. 4 is an exploded perspective view illustrating a battery unit illustrated in FIG. 1.

FIG. 5 is an enlarged view of a portion V of FIG. 3.

FIG. 6 is a perspective view corresponding to FIG. 5.

### DETAILED DESCRIPTION OF CERTAIN INVENTIVE EMBODIMENTS

Reference will now be made in detail to embodiments, examples of which are illustrated in the accompanying drawings. Effects and features of the embodiments, and implementation methods thereof will be clarified through the following descriptions given with reference to the accompanying drawings. In this regard, the embodiments can have different forms and should not be construed as being limited to the descriptions set forth herein. As used herein, the term “and/or” includes any and all combinations of one or more of the associated listed items. Expressions such as “at least one of,” when preceding a list of elements, modify the entire list of elements and do not modify the individual elements of the list.

Hereinafter, embodiments will be described in detail with reference to the accompanying drawings. In the drawings, like reference numerals denote like elements, and overlapping descriptions thereof will be omitted.

In the following descriptions of the embodiments, although the terms “first and second” are used to describe various elements, these elements should not be limited by these terms. These terms are only used to distinguish one element from another element.

In the following descriptions of the embodiments, the terms of a singular form can include plural forms unless referred to the contrary.

In the following descriptions of the embodiments, the meaning of “include,” “comprise,” “including,” or “comprising,” specifies a property, a region, a fixed number, a step, a process, an element, a component, and a combination thereof but does not exclude other properties, regions, fixed numbers, steps, processes, elements, components, and combinations thereof.

It will be understood that when a film, a region, or an element is referred to as being “above” or “on” another film, region, or element, it can be directly on the other film, region, or element, or intervening films, regions, or elements can also be present.

In the drawings, the sizes of elements can be exaggerated for clarity. For example, in the drawings, the size or thickness of each element can be arbitrarily shown for illustrative purposes, and thus the described technology should not be construed as being limited thereto. In this disclosure, the term “substantially” includes the meanings of completely, almost completely or to any significant degree under some applications and in accordance with those skilled in the art. Moreover, “formed on” can also mean “formed over.” The term “connected” can include an electrical connection.

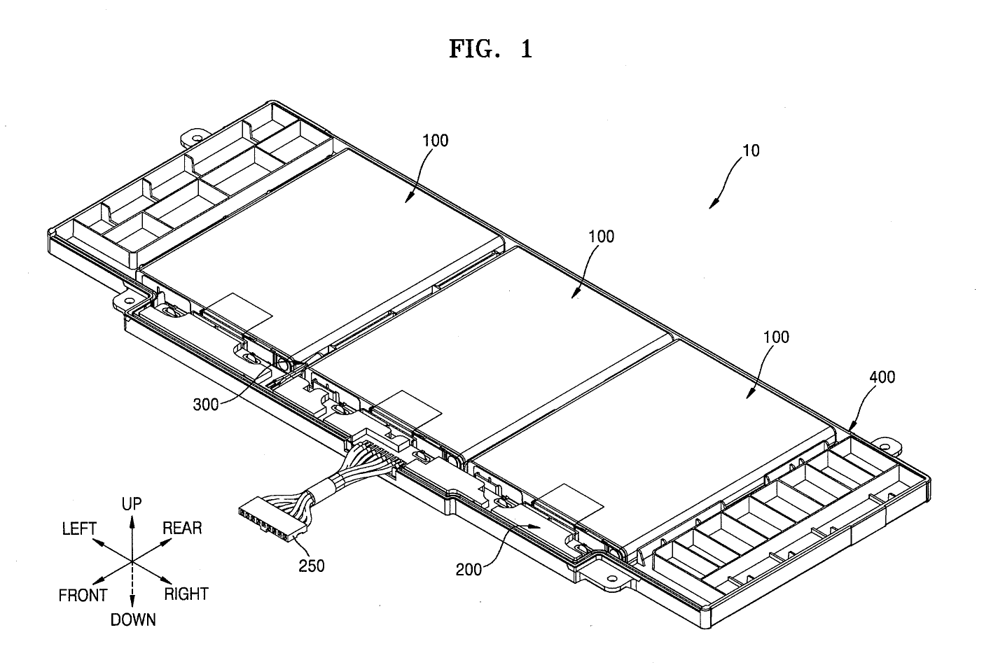

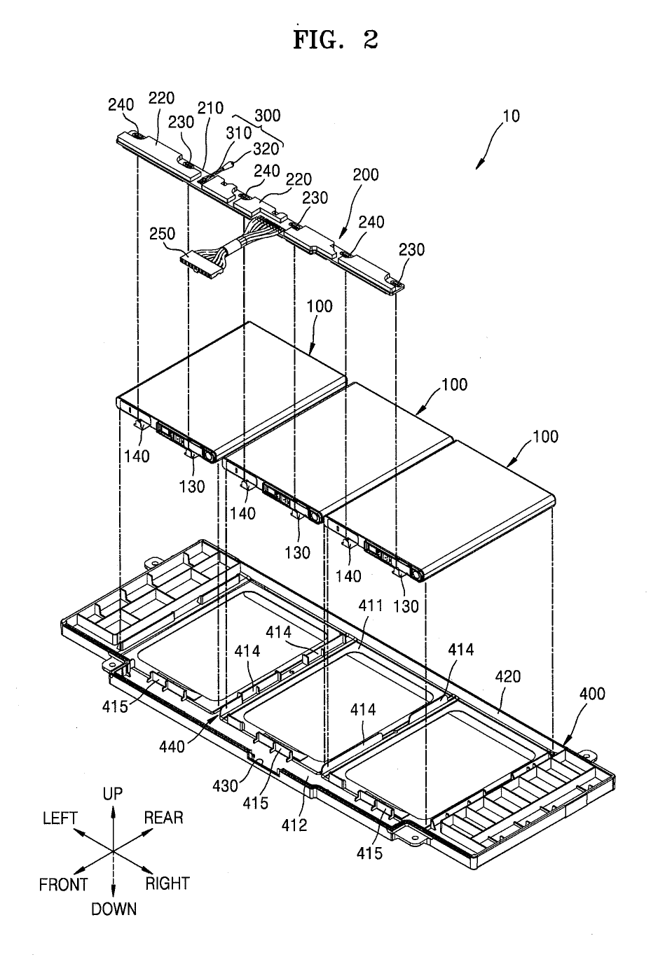

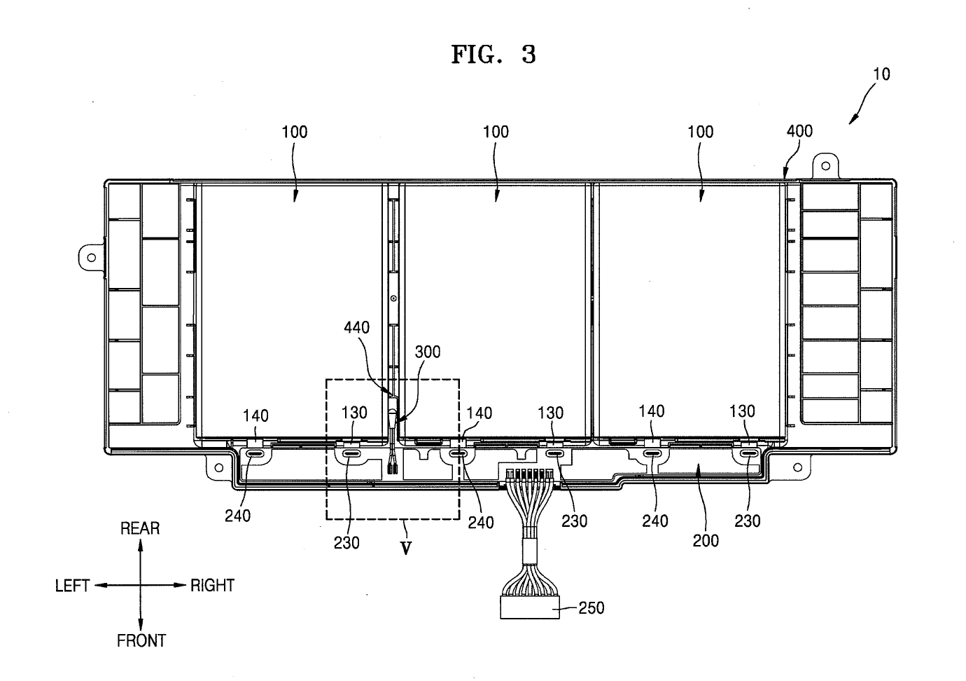

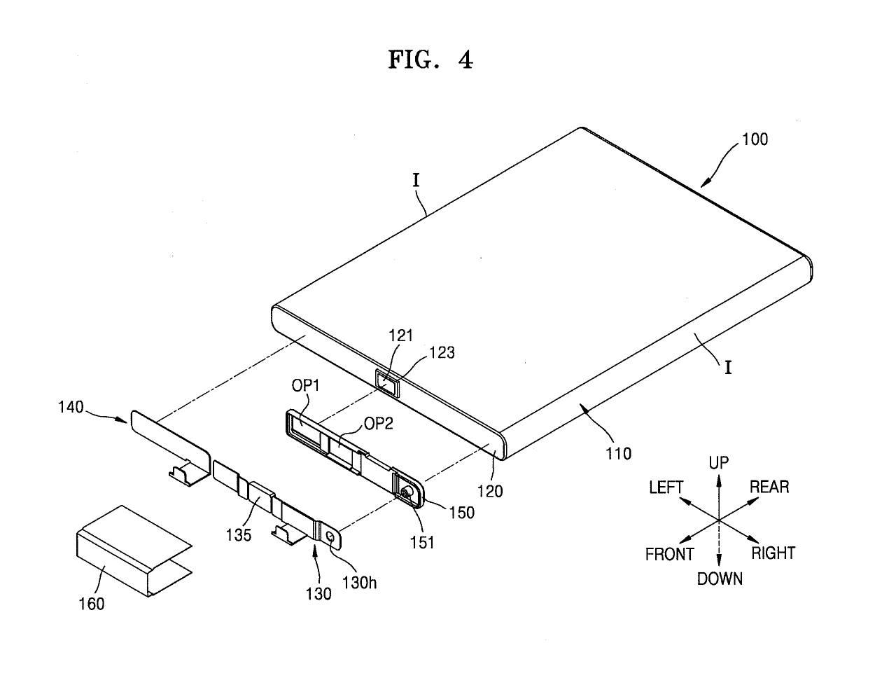

FIG. 1 is a perspective view schematically illustrating a battery pack according to an embodiment. FIG. 2 is an exploded perspective view illustrating the battery pack illustrated in FIG. 1. FIG. 3 is a plan view illustrating an upper side of the battery pack illustrated in FIG. 1. FIG. 4 is an exploded perspective view schematically illustrating a battery unit according to an embodiment.

Referring to FIGS. 1 to 3, a battery pack 10 includes a plurality of battery units or batteries 100, a protective circuit module 200, a temperature sensor 300, and a case

The battery units 100 can be arranged side by side in one direction. For example, the battery units 100 can be arranged side by side in such a manner that sides (for example, front sides) of the battery units 100 can face substantially the same direction. Lateral sides of neighboring pairs of the battery units 100 can face each other. The battery units 100 can be rechargeable secondary battery cells such as lithium-ion battery cells; however, the battery units 100 are not limited thereto.

Referring to FIG. 4, each of the battery units 100 has a prismatic shape. Each of the battery units 100 can include a can or container 110, an electrode assembly (not shown) accommodated in the can 110 through an opening formed in the can 110, a cap plate 120 that can cover the opening of the can 110, a first electrode tab 130, and a second electrode tab 140.

The can 110 can have a hexahedral shape with an opened top side and formed of a metallic material so that the can 110 can have durability and resistance against impact. For example, the can 110 can be formed of aluminum or an aluminum alloy. After the electrode assembly is inserted into the can 110, the opening of the can 110 can be hermetically closed by the cap plate 120. Like the can 110, the cap plate 120 can be formed of a metallic material such as aluminum or an aluminum alloy. The cap plate 120 and the can 110 can be welded together using a laser and thereby seal the inside of the can 110.

When the battery units 100 are arranged side by side as shown in FIG. 1, neighboring pairs of the battery units 100 can be insulated from each other by using an insulator such as insulation tape I (see FIG. 4) wrapped around the battery units 100 so as to prevent a short-circuit therebetween.

The electrode assembly can include first and second electrode plates coated with electrode active materials, and a separator placed between the first and second electrode plates. The electrode assembly can be formed by sequentially stacking the first electrode plate, the separator, and the second electrode plate, and winding them in the form of a jelly roll.

In some embodiments, the electrode assembly has a jelly roll shape. However, the embodiments are not limited thereto. For example, in some embodiments, a stack in which a first electrode plate, a separator, and a second electrode plate are sequentially stacked can be used as an electrode assembly.

An electrode pin 121 is formed on the cap plate 120. The first electrode plate can be electrically connected to the electrode pin 121, and the second electrode plate can be electrically connected to the cap plate 120. Since the first and second electrode plates have different polarities, the electrode pin 121 and the cap plate 120 have different polarities. For example, the electrode pin 121 can have a negative polarity, and the cap plate 120 can have a positive polarity, or vice versa. A gasket 123 can be placed between the electrode pin 121 and the cap plate 120 so as to prevent a short-circuit therebetween.

The first and second electrode tabs 130 and 140 can be placed on the cap plate 120. The first electrode tab 130 is placed in a first region of the cap plate 120, and the second electrode tab 140 is placed in a second region of the cap plate 120. For example, the first electrode tab 130 can be placed on the cap plate 120 and be electrically connected to the electrode pin 121. The second electrode tab 140 can be placed on the cap plate 120 and be electrically connected to the cap plate 120.

The first electrode tab 130 can include a temperature cutoff (TCO) device 135. Because the first electrode tab 130 is electrically connected to the electrode pin 121, the first electrode tab 130 can have a negative polarity. In this situation, since the cap plate 120 has a positive polarity, the first electrode tab 130 placed on the cap plate 120 can be short-circuited with the cap plate 120. Therefore, a holder 150 can be placed between the first electrode tab 130 and the cap plate 120 for electric insulation therebetween.

The holder 150 is directly placed on the cap plate 120. The holder 150 includes a first opening OP1 to electrically connect the first electrode tab 130 to the electrode pin 121. In addition, the holder 150 can further include a second opening OP2 formed at a position facing the TCO device 135, and thus the TCO device 135 can respond to a temperature variation of the battery unit 100.

The holder 150 includes a protrusion 151 for fixing the first electrode tab 130 to the holder 150. After the first electrode tab 130 is placed on the holder 150, the first electrode tab 130 can be welded to the electrode pin 121 and fixed to the protrusion 151. For example, after the protrusion 151 is inserted into a hole 130h, an upper portion of the protrusion 151 can be heated and fused to fix the first electrode tab 130 to the holder 150. A tape 160 can be attached so that the first electrode tab 130 is not separated from the battery unit 100.

In FIGS. 1 to 3, the battery pack 10 includes three battery units 100. However, the embodiments are not limited thereto. For example, in some embodiments, the battery pack can include two, four, or more battery units 100.

In FIGS. 1 to 3, the three battery units 100 are arranged side by side in one direction. However, the embodiments are not limited thereto. For example, the battery units 100 shown in FIG. 1 can be differently arranged as follows: the lateral sides of the left two battery units 100 can face each other with the temperature sensor 300 therebetween, and the front side of the rightmost battery unit 100 can be exposed in a different direction.

The protective circuit module 200 can be placed at a position adjacent to the sides of the battery units 100. For example, the protective circuit module 200 can be placed at a position adjacent to the front sides of the battery units 100.

The protective circuit module 200 can be electrically connected to the battery units 100 so as to control charging and discharging operations of the battery units 100. The protective circuit module 200 can prevent overheating or explosion of the battery units 100 caused by overcharging, overdischarging, or an overcurrent. The battery units 100 and the protective circuit module 200 can be electrically connected by inserting the first and second electrode tabs 130 and 140 placed on the front sides of the battery units 100 into terminal holes 230 and 240 of the protective circuit module 200 and soldering the electrode tabs 130 and 140 to the protective circuit module 200.

The protective circuit module 200 can include a circuit board 210, protection devices 220 placed on the circuit board 210, and a connector 250. For example, the circuit board 210 can extend in a direction in which the battery units 100 are arranged. The protection devices 220 can be safety devices including passive devices such as resistors or condensers or active devices such as field-effect transistors, or integrated circuits.

A circuit pattern is formed on the circuit board 210 so as to electrically connect the battery units 100 in series and/or parallel. Therefore, since the first and second electrode tabs 130 and 140 are electrically connected to the circuit board 210 through the terminal holes 230 and 240, charging and discharging of the battery units 100 can be controlled by operations of the protection devices 220, and the battery units 100 can be electrically connected in series and/or parallel.

The connector 250 can be placed on an end of the protective circuit module 200 for electric connection with an external electronic device. The connector 250 can be exposed to the outside through a recess 430 formed in a side of the case 400.

The temperature sensor 300 can be placed between neighboring battery units 100 so as to sense temperatures of the neighboring battery units 100. The temperature sensor 300 can be a thermistor. The temperature sensor 300 can include a cable 310 and a main body 320 placed on an end of the cable 310. The other end of the cable 310 can be electrically connected to the protective circuit module 200, and temperature data obtained by the main body 320 can be transmitted to the protective circuit module 200 through the cable 310.

The first and second electrode tabs 130 and 140 placed on the front sides of the battery units 100 can be formed of a conductive metallic material. In some embodiments, because the first and second electrode tabs 130 and 140 have both thermal and electrical conductivity, the first and second electrode tabs 130 and 140 can be easily affected by temperature variations of the battery units 100 and the protection devices 220.

If the temperature sensor 300 is adjacent to sides of the battery units 100 on which the first and second electrode tabs 130 and 140 are placed (that is, if the temperature sensor 300 is adjacent to the front sides of the battery units 100), the temperature sensor 300 can be affected by the temperatures of the first and second electrode tabs 130 and 140 and/or the temperatures of the protection devices 220 in addition to the temperatures of the battery units 100. Thus, in some embodiments, when the temperature sensor 300 is so placed, the temperature sensor 300 does not sense the temperatures of the battery units 100 accurately.

However, according to some embodiment, the temperature sensor 300 is formed between neighboring battery units 100, for example, between lateral sides of neighboring battery units 100. Therefore, the temperature sensor 300 can be minimally affected by elements (for example, the first and second electrode tabs 130 and 140 and/or the protection devices 220) other than the battery units 100.

The case 400 can accommodate the battery units 100 and the protective circuit module 200. The case 400 can be formed of an insulation material. For example, the case 400 can be formed of a polymer compound such as plastic material that is deformable into a desired shape by heat or pressure.

The case 400 can include: first and second bottom ribs 411 and 412 facing the lower sides of the battery units 100 and a lower side of the protective circuit module 200. Outer walls 420 can substantially surround the battery units 100 and the protective circuit module 200 and extend in a thickness direction (down-to-up direction in FIG. 1). Barrier walls 414 and 415 can be formed inside the case 400 to determine the positions of the protective circuit module 200 and the battery units 100. The battery units 100 and the protective circuit module 200 can be accommodated in the case 400 through an opened top side of the case 400.

A rib 440 can be formed between a neighboring pair of the battery units 100. The rib 440 can form an accommodation space in which the temperature sensor 300 is placed. When the battery pack is impacted during or after an assembling process, the rib 440 can protect the temperature sensor 300 from breaking.

The rib 440 can define the accommodation space in a length direction of a neighboring pair of the battery units 100 (front-to-rear direction in FIG. 1). The rib 440 can have substantially the same height as that of the outer walls 420 or can be shorter than the outer walls 420.

A portion of the bottom side of the case 400 can have openings in regions corresponding to center regions of the battery units 100. For example, the portion of the bottom side of the case 400 can be opened except for the first bottom ribs 411 supporting the bottom sides of the battery units 100 and the second bottom rib 412 corresponding to the bottom side of the protective circuit module 200. The top side of the case 400 can be opened to receive the battery units 100 and the protective circuit module 200. After the battery units 100 and the protective circuit module 200 are accommodated in the case 400, the case 400 can be wrapped with a label (not shown).

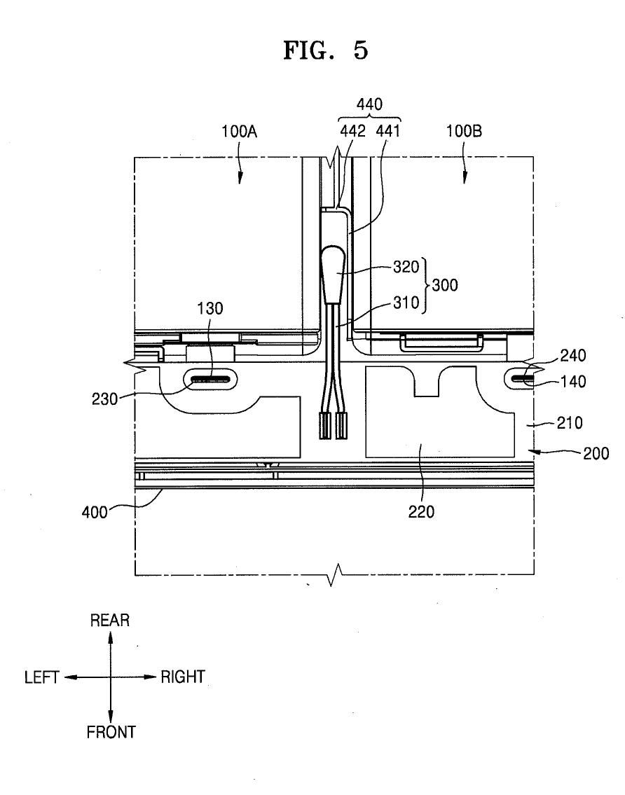

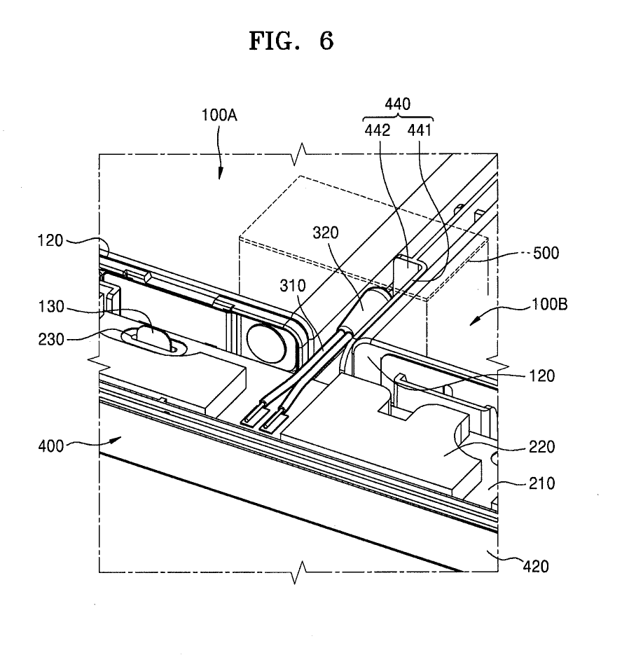

Hereinafter, explanations will now be given of the structure of the rib 440 and how the temperature sensor 300 is accommodated, with reference to FIGS. 5 and 6.

FIG. 5 is an enlarged perspective view illustrating a portion V of FIG. 3. FIG. 6 is a perspective view corresponding to FIG. 5.

Referring to FIGS. 5 and 6, the rib 440 can include a first portion 441 and a second portion 442 substantially perpendicular to the first portion 441.

The first portion 441 can extend in a length direction (front-to-rear direction) of the lateral sides of neighboring first and second battery units 100A and 100B. The second portion 442 can be substantially perpendicular to the first portion 441. The second portion 442 can be fitted in a gap between the neighboring first and second battery units 100A and 100B. For example, the width of the second portion 442 can be substantially the same as the width of the gap between the neighboring first and second battery units 100A and 100B. The lateral sides of the neighboring first and second battery units 100A and 100B can contact both ends of the second portion 442. In some embodiments, the second portion 442 functions as a fixing portion to prevent wobbling of the neighboring first and second battery units 100A and 100B. The second portion 442 can protect the temperature sensor 300 from damage caused by collision with the neighboring first and second battery units 100A and 100B.

The protective circuit module 200 can be placed adjacent to the cap plates 120 of the neighboring first and second battery units 100A and 100B and can be coupled to the first and second electrode tabs 130 and 140 formed on the cap plates 120. An end of the temperature sensor 300 can be fixed to the protective circuit module 200. When the protective circuit module 200 is accommodated in the case 400, the temperature sensor 300 can also be accommodated in the case 400 together with the protective circuit module 200.

The rib 440 can be formed between the lateral sides adjacent to the cap plates 120 so as to reduce the length of the cable 310 and easily place the temperature sensor 300 and the protective circuit module 200 in the case 400. The temperature sensor 300 placed in the accommodation space formed by the rib 440 can extend in the front-to rear direction substantially parallel to the lengths of the neighboring first and second battery units 100A and 100B and substantially perpendicular to a left-to-right direction of the protective circuit module 200.

The temperature sensor 300 can be inserted between the lateral sides from a side of the protective circuit module 200. In another example, the first and second battery units 100A and 100B, placed on the left and right sides of the temperature sensor 300, can be electrically connected to each other through a metal member (not shown) extending in the left-to-right direction and welded to the cap plates 120. In this case, the temperature sensor 300 can be blocked by the metal member, and thus it can be difficult to insert the temperature sensor 300 between the first and second battery units 100A and 100B.

However, in some embodiments, since the neighboring first and second battery units 100A and 100B are electrically connected through the circuit pattern of the protective circuit module 200, the metal member is not used, and thus the temperature sensor 300 can be freely inserted.

The temperature sensor 300 can be spaced apart from the first and second electrode tabs 130 and 140, and thus, the sensing efficiency of the temperature sensor 300 can be improved. When the temperature sensor 300 (particularly, the main body 320 of the temperature sensor 300) is adjacent to the first and second electrode tabs 130 and 140 or the metal member that electrically connect the first and second battery units 100A and 100B to each other, the temperature sensing can be affected by the temperatures of the first and second electrode tabs 130 and 140 or the temperature of the metal member in addition to the temperatures of the battery units 100.

However, in some embodiments, the first and second electrode tabs 130 and 140 are placed on the front sides of the first and second battery units 100A and 100B (that is, on the cap plates 120), and the temperature sensor 300 is placed between the lateral sides of the first and second battery units 100A and 100B. Therefore, in some embodiments, the temperature sensor 300 is not affected by the temperatures of elements other than the battery units 100.

The rib 440 and the case 400 can be formed integrally as one piece by an injection molding method, and the rib 440 can extend upward from the bottom side of the case 400. The height of the rib 440 can be substantially the same as the height of the outer walls 420 or shorter than the outer walls 420. As described above, since the top of the case 400 is opened as a whole, an upper side of the temperature sensor 300 placed in the accommodation space formed by the rib 440 can be exposed to the outside though the opened top of the case 400. An adhesive member can be placed on the temperature sensor 300 so as to prevent separation of the temperature sensor 300 from the case 400 through the opened top of the case 400. For example, the adhesive member can be an adhesive insulation film 500 (refer to FIG. 6). One end of the adhesive insulation film 500 can be bonded to the first battery unit 100A, and the other end of the adhesive insulation film 500 can be bonded to the second battery unit 100B.

In some embodiments, the adhesive insulation film 500 is placed on the first and second battery units 100A and 100B. However, the disclosed embodiments are not limited thereto. In other embodiments, an adhesive such as polymer paste that can be hardened with time can be applied to the temperature sensor 300. For example, after the temperature sensor 300 is placed in the accommodation spaced formed by the rib 440, polymer paste can be applied to a portion of the cable 310 and can be hardened to fix the position of the temperature sensor 300.

As described above, according to the one or more of the above embodiments, breaking of the temperature sensor can be prevented, and the temperature sensing efficiency of the temperature sensor can be improved.

It should be understood that the exemplary embodiments described herein should be considered in a descriptive sense only and not for purposes of limitation. Descriptions of features or aspects within each embodiment should typically be considered as available for other similar features or aspects in other embodiments.

While the inventive technology has been described with reference to the figures, it will be understood by those of ordinary skill in the art that various changes in form and details can be made therein without departing from the spirit and scope of the present invention as defined by the following claims.

1. A battery pack comprising:
a plurality of battery units each comprising:
a container;
an electrode assembly accommodated in the container and including first and second electrode plates and a separator placed therebetween;
a cap plate substantially sealing the electrode assembly in the container; and
an electrode tab placed on the cap plate;
a protective circuit module placed adjacent to sides of the battery units and electrically connected to the battery units;
a case accommodating the battery units;
a temperature sensor placed between neighboring battery units of the plurality of battery units, wherein the neighboring battery units are separated from each other such that a gap is provided between the neighboring battery units; and
a rib placed between neighboring battery units and accommodating the temperature sensor, wherein a portion of the rib is fitted in the gap between the neighboring battery units.

2. The battery pack of claim 1, wherein the neighboring battery units are arranged side by side such that the cap plates face substantially the same sides of the battery units, and
wherein the protective circuit module is placed adjacent to the cap plates.

3. The battery pack of claim 1, wherein each battery unit has a substantially prismatic shape,
wherein lateral sides of the neighboring battery units are arranged to face each other, and
wherein the lateral sides are substantially perpendicular to the cap plates of the neighboring battery units.

4. The battery pack of claim 3, wherein the rib comprises:
a first portion extending in a first direction; and
a second portion extending in a second direction crossing the first direction.

5. The battery pack of claim 4, wherein the first direction extends substantially parallel to the lateral sides.

6. The battery pack of claim 4, wherein the second portion has substantially the same width as the width of the gap formed between the neighboring battery units.

7. The battery pack of claim 1, wherein the temperature sensor comprises a thermistor.

8. The battery pack of claim 1, wherein the battery units are electrically connected in series, parallel, or a combination thereof via a circuit pattern of the protective circuit module.

9. The battery pack of claim 1, wherein the temperature sensor is substantially parallel to a length direction of the neighboring battery units.

10. The battery pack of claim 1, further comprising an adhesive insulation film placed on the temperature sensor.

11. The battery pack of claim 1, wherein the container is formed of a metal.

12. A battery pack comprising:
first and second battery units having a substantially prismatic shape and separated from each other, wherein lateral sides of the first and second battery units face each other such that a gap is provided between the first and second battery units;
a protective circuit module electrically connected to the first and second battery units;
a case accommodating the first and second battery units;
a rib formed between the first and second battery units; and
a temperature sensor accommodated in the rib,
wherein a portion of the rib is fitted between the first and second battery units.

13. The battery pack of claim 12, wherein the first and second battery units each comprises an electrode tab placed on a front side of the respective battery unit, and wherein the front side and the lateral side are placed on different planes.

14. The battery pack of claim 13, wherein the first and second battery units are arranged side by side such that the electrode tabs face the same sides of the first and second battery units.

15. The battery pack of claim 13, wherein the protective circuit module is placed adjacent to the electrode tabs.

16. The battery pack of claim 12, wherein the temperature sensor extends in a length direction of the lateral sides, and
wherein the protective circuit module extends in a direction crossing the length direction.

17. The battery pack of claim 12, wherein the portion of the rib contacts the lateral sides of the first and second battery units.

18. The battery pack of claim 17, wherein the portion of the rib has substantially the same width as a width of the gap formed between the first and second battery units.

19. The battery pack of claim 12, wherein the first and second battery units are electrically connected in series or parallel via the protective circuit module.

20. The battery pack of claim 12, further comprising an adhesive member placed on the temperature sensor.
